(19) United States
(12) Patent Application Publication
(10) Pub. No.: US 2010/0060522 A1
(43) Pub. Date: Mar. 11, 2010

(54) Antenna Arrangement

(75) Inventors: Par Backlund, Bromma (SE); Anette Borg, Stockholm (SE); Jonas Karlsson, Sollentuna (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/520,737

(22) PCT Filed: Dec. 22, 2006
(86) PCT No.: PCT/SE2006/050619

§ 371 Date: Jun. 22, 2009

(51) Int. Cl. H01Q 3/36

(52) U.S. Cl. 342/372

(57) ABSTRACT

In a cellular communications system the antenna tilt may be varied in order to achieve different degrees of overlap between different cells, in dependence of the service being transmitted. For a broadcast service the antenna tilt may be set to maximize the overlap, while for a data or speech connection the antenna tilt may be set to minimize the overlap.

### TECHNICAL FIELD

The present invention relates to an antenna system and in particular to the adaptive control of antennas.

### BACKGROUND

In cellular networks, typically, several base stations are used to transmit signals to mobile terminals in different locations. Typically, the area covered by a base station is referred to as a cell. Conventional cellular antennas broadcast energy equally over the entire cell. In recent years adaptive antennas have been introduced, in order to increase the capacity in the cell. Adaptive antennas are antenna arrays that confine the broadcast energy to a narrow beam, typically four or eight in each cell. Adaptive antennas are discussed in, for example, Derneryd and Johannisson: “Adaptive base-station antenna arrays”, Ericsson Review No. 3, 1999, pp. 132-137 and Andersson et al.: “Enhancing cellular network capacity with adaptive antennas”, Ericsson Review No. 3, 1999; pp. 138-141.

In order to minimize interference the overlap between cells should be as small as possible, as this will prevent pilot pollution and make sharp best server border areas. This is desirable for speech and data traffic intended for one receiving terminal only, for example, Dedicated Channel (DCH) traffic in the 3GPP release 99 (R99) and High Speed Downlink Packet Access (HSDPA) traffic.

To define a cell in the best possible way each antenna is tilted vertically and/or horizontally so that its antenna lobe will cover a desired subarea of a whole area, in such a way that all antenna lobes from all base stations together cover the whole area with a minimum of overlap between them. This may be done simply by physically mounting each antenna at a desired angle to achieve a mechanical tilt. The tilt can also be achieved by applying a phase shift to the signal to each antenna element. This is referred to as an electrical tilt.

For broadcast services such as the Multimedia Broadcast and Multicast Service (MBMS) it is instead desirable to maximize the overlap between different cells to enable soft combining to achieve maximum macro diversity. Data transmitted in this way may be, for example, television programs. For such data, therefore, the antennas should be tilted in such a way as to achieve an overlap between the cells. In the state of the art this can only be achieved by providing an extra set of antennas in addition to the ones used for speech or data traffic, and having a tilt that will enable an overlap.

WO 02/47207 discloses an antenna system intended for use as an add-on to an existing base station, to enable independent control of multi-beams in dependence of traffic intensity distribution by applying different tilts to different beams. In this way resources can be directed to the areas where they are needed at any given time. This document, however, only discloses the use of speech and data signals intended for one receiving mobile terminal.

### SUMMARY

It is an object of the invention to improve the utilization of network resources in broadcast services.

This object is achieved according to the present invention by an antenna system comprising
an antenna array for transmitting at least one signal on a corresponding carrier frequency, said antenna array having at least two transmitting elements, and
phase shift control means arranged to control the phase shift of the antenna array to achieve an electrical tilt in dependence of the type of service carried by the signal.

The object is also achieved by a base station for use in a cellular telecommunications network, for controlling the transmission of signals through at least one antenna array, said base station being characterized in that it comprises control means arranged to control the transmission of a signal in dependence of the type of service carried by the signal.

The object is also achieved by a computer program for use in a base station, said computer program comprising computer readable code means which will cause a control unit in the base station to perform the following functions when the base station receives a signal from the network that is to be transmitted to one or more terminals:
determine the type of service that is to be transmitted and
control the transmission of the signal in such a way that the signal is transmitted with a desired tilt depending on the type of service carried by the signal.

Hence, according to the invention a service that could benefit from macro diversity, such as a broadcast service, could be transmitted from the same antenna as speech or data services intended for one recipient. Using different tilts for different services the cells can be made to overlap for broadcast services, enabling macro diversity for such services while the overlap between the cells is minimized for other services. The control functions may be implemented in the antenna, in the base station, or distributed between both.

According to one embodiment a passive antenna is used, in which case the antenna system preferably comprises a first antenna array and a second antenna array, said phase shift control means comprising a first knob for electrically phase shifting the signals to be transmitted on the first antenna array and a second knob for electrically phase shifting the signals to be transmitted on the second antenna array and a carrier selection means for selecting one of the first and second antenna array to transmit an outgoing signal in dependence of the type of service carried by the signal. The knobs may be kept in fixed positions. Alternatively, one or both knobs may be turned to adjust the antenna tilt. The knobs may be turned manually or using mechanical means such as a remote controlled step motor. How to use a knob to adjust the tilt of a passive antenna is known per se. Instead of using knobs the tilt may be introduced electronically. For example, a phase shift may be introduced by means of electrically controlled analog vector modulator technology. How to introduce a phase shift in this way is known in the art. Alternatively a fix tilt may be preset during manufacturing.

In this embodiment the control means is arranged to select one of at least two antenna arrays for transmitting the signal in dependence of the tilt applied to each antenna array and the type of service carried by the signal. The computer program is arranged to control the transmission by selecting an antenna array to transmit the signal, said antenna array having the desired tilt in dependence of the service carried by the signal.

According to another embodiment, said antenna elements are active elements, said phase shift control means comprising means for identifying the type of service to be transmitted by the antenna array and adjusting means for adjusting the phase shift of the signals in dependence of the type of service.

If an active element is used, the antenna system preferably comprises means for providing a pilot channel having a phase shift determined in dependence of the phase shift of the signal also containing the service. This is done to enable MBMS channels to be transmitted on a separate antenna branch or element, or with a different phase relative to the pilot channel.

In this second embodiment the control means is arranged to apply a phase shift to the signal in dependence of the type of service carried by the signal, to achieve the desired tilt. The computer program is arranged to control the transmission by applying the appropriate phase shift to achieve the desired tilt in dependence of the service carried by the signal.

Preferably, the control means of the second embodiment is also arranged to apply a phase shift to a pilot signal in dependence of the phase shift applied to the corresponding signal.

### BRIEF DESCRIPTION OF THE DRAWINGS

The invention will be described in more detail in the following, by way of example and with reference to the appended drawings in which:

FIG. 1 illustrates the lobes transmitted from a first and a second base station according to the prior art.

FIG. 2 illustrates the lobes that may be transmitted from a first and a second base station according to the invention.

FIG. 3 illustrates an embodiment of the invention using a passive antenna.

FIG. 4 illustrates a first embodiment of the invention using an active antenna.

FIG. 5 illustrates a second embodiment of the invention using an active antenna.

### DETAILED DESCRIPTION

FIG. 1 illustrates the part of a cellular network known in the art in which a first and a second base station 1, 3 transmit signals, from respective antennas in respective lobes 5, 6. As can be seen, the antenna lobes 5, 6 are tilted at an angle so as to minimize the overlap between the areas covered by the lobes. This is suitable for some services, such as speech or data traffic intended for individual terminals.

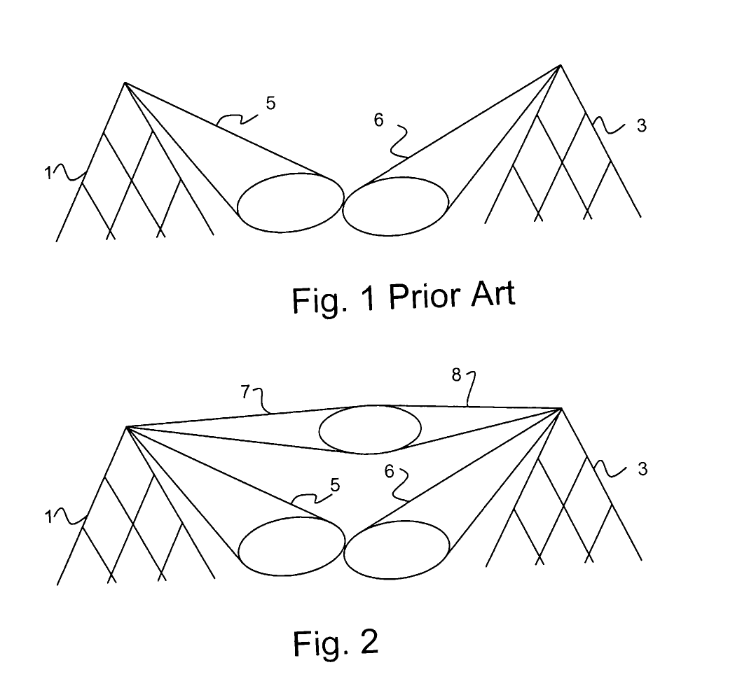

FIG. 2 illustrates a cellular network known in the art, in which a first and a second base station 1, 3 transmit signals. As in FIG. 1 each base station transmits a first antenna lobe 5, 6 that is tilted to avoid overlap between the areas covered by the lobes, to optimize traffic intended for individual terminals. In addition, the base stations should be able to transmit broadcast data services, such as Multimedia Broadcast/Multicast Service (MBMS) data. In this case, the terminals would benefit from being able to receive the same signal from different base stations to enable soft combining gain. By utilizing the possibility of soft combining gain the transmission power for such data can be reduced. Therefore, the base stations 1, 3 are also able to transmit a second antenna lobe 7, 8 tilted in such a way as to maximize the overlap. These second antenna lobes 7, 8 are suitable for broadcast data in which diversity can be used to achieve a combining gain.

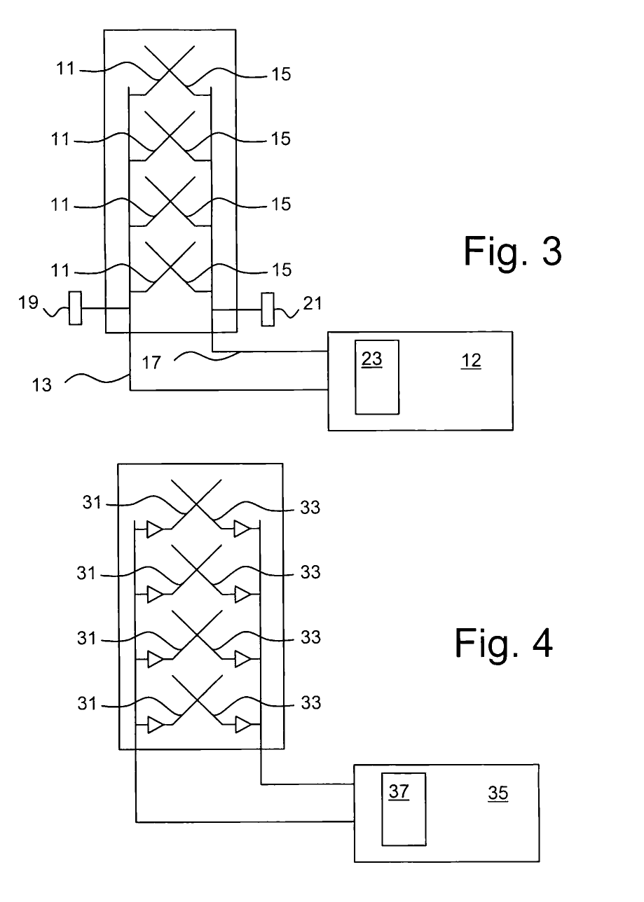

FIG. 3 illustrates a first embodiment of the invention implemented in a base station as shown in FIGS. 1 and 2, using a passive antenna. In this case, two services are transmitted on different carrier frequencies in the same system. A first passive antenna array of transmitting and receiving antenna elements 11 is connected to the base station 12 through a wired connection 13. The base station per se is known to the skilled person and is therefore not shown in detail here. A second passive antenna array 15 of transmitting and receiving antenna elements is also connected to the base station through a second wired connection 17. Two sets of transmitting antenna elements, that is, two transmitting arrays 11, 15 are needed to achieve the inventive object using a passive antenna. If more than two antenna arrays are used more different tilts can be provided for different services.

In FIG. 3 the different services are transmitted in the antenna on different antenna arrays. According to the invention, a phase shift is applied to each antenna array 11, 15. This phase shift may be referred to as an electrical tilt. The electrical tilt is achieved in a way known per se. It is known to use a knob to control the antenna elements of both arrays 11, 15 simultaneously to apply the same amount of electrical tilt to both of them. According to the invention, however, a first knob 19 is arranged to control the first antenna array 11 and a second knob 21 is arranged to control the second antenna array 15. Preferably the first antenna array 11 is set to a tilt suitable for a first type of service, for example, speech and data traffic and the second antenna array 15 is set to a tilt suitable for a second type of traffic, for example broadcast. In this case the tilt applied to the first antenna array 11 should result in very little overlap with other lobes, while the tilt applied to the second antenna array 15 should be selected to maximize the overlap with other lobes. The tilts may be fixed or it may be possible to adjust the tilt of each antenna array 11, 15 by means of the knobs 19, 21. The knobs may be adjusted manually or by remote controlled adjustment means such as a step motor. How to use the knobs to adjust the tilt is known per se. Instead of using knobs the tilt may be introduced electronically. For example, a phase shift may be introduced by means of electrically controlled analogue vector modulator technology. How to introduce a phase shift in this way is known in the art.

If a fixed tilt is used the tilt may be preset by the manufacturer. In this case, an antenna having the desired tilt can be purchased directly in cases when there is no need to adjust the tilt.

The base station 12, knowing which tilt is applied to which antenna array, then comprises a carrier selection means 23 for determining which antenna array 11, 15 should be used to transmit a particular carrier in dependence of the type of service carried by this carrier.

Since the phase shift is individual for each antenna array it can be adapted for each service. In this case +/−45 degrees polarization diversity is used but +/−90 degrees, or space diversity, could also be applied. With individual vertical tilt for each service transmitted on an individual carrier the optimal service requirements can be tuned by changing the tilt through a phase shift of the signal.

In the embodiment shown in FIG. 3 the carrier selection means 23 comprises a computer program arranged to perform the following functions when the base station receives a signal from the network that is to be transmitted to one or more terminals:
1. determine the type of service that is to be transmitted and
2. select the antenna array having the desired tilt in dependence of the service carried by the signal.

In practice, which service to transmit on which carrier is often predefined in a static manner.

FIG. 4 illustrates a first embodiment in a base station as shown in FIGS. 1 and 2, in which an active antenna is used. The antenna comprises at least one antenna array. In FIG. 4 the antenna comprises a first array 31 of antenna elements and a second array 33 of antenna elements, both of which are connected to a base station 35. As in FIG. 3 the base station is not shown in detail; instead, only the part specific to the invention is shown. In this case the phase shift can be applied as a part of the signal processing in the base station. Therefore, two different services may be transmitted on the same carrier frequency, that is, by the same antenna array, for example the first array 31. In this case, as in FIG. 3, a different electrical tilt is applied for each service. The difference is that in FIG. 3, different carriers were used for different services, whereas in FIG. 4 different services may be transmitted on the same carrier frequency and the vertical tilt for each service is achieved by modifying the individual delay/phase shift of the signal for each antenna element in the base station. The base station comprises a selection means 37 for identifying the type of service and for applying the phase shift in dependence of the type of service, to achieve the desired degree of non-overlap/overlap with other cells with the same service.

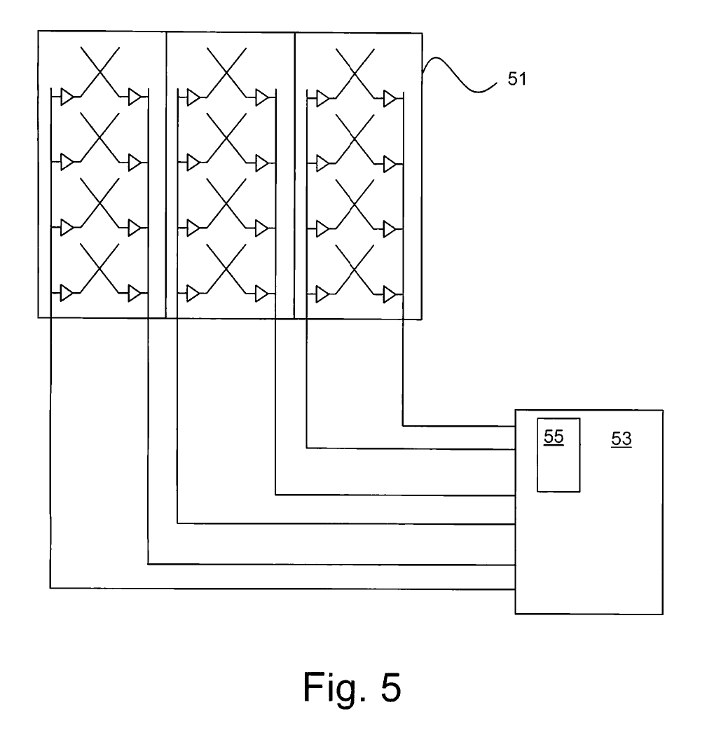

FIG. 5 illustrates a second embodiment using an active antenna in a base station as shown in FIGS. 1 and 2, in this case comprising a vertical and horizontal array antenna. In FIG. 5, as an example, the antenna array comprises three rows and three columns of pairs of antenna elements. The antenna is connected to a base station 53 as is common in the art. Again, only the part of the base station specific to the invention is shown. As in FIG. 4 the phase shift can be applied as a part of the signal processing by a selection unit 55 in the base station 53 and two different services may be transmitted on the same carrier frequency using different phase shifts for the signals belonging to each service. In addition to the vertical tilt achieved according to FIG. 4, a horizontal tilt may also be achieved. Applying a horizontal tilt by means of a horizontal array in order to aim at a particular user is known per se. According to the invention both a horizontal and a vertical tilt can be applied in dependence of the service, to achieve a desirable level of overlap for each service. As will be readily understood by the skilled person this embodiment enables a particularly flexible way of controlling the overlap between antenna lobes in dependence of the service that is transmitted.

In the embodiments shown in FIGS. 4 and 5 the control unit 37, 55 comprises a computer program arranged to perform the following functions when the base station receives a signal from the network that is to be transmitted to one or more terminals:

1. determine the type of service that is to be transmitted and

2. apply the appropriate phase shift to achieve the desired tilt in dependence of the service carried by the signal.

In the present 3GPP standard a common pilot channel (CPICH) is defined. The CPICH is a continuous predefined sequence that is broadcasted with constant power into the entire cell (primary CPICH) or just into a part of the cell (secondary CPICH) when adaptive antennas are used. Mobile terminals operating in a network using a fixed beam method can use the secondary CPICH for channel estimation if the secondary CPICH is also transmitted on the serving beam together with the data channel of the served users. For MBMS, as defined in the 3GPP specification (3GPP TS 25.211 V6.7.0 (2005-12), there is presently no secondary CPICH. To enable MBMS channels to be transmitted on a separate antenna branch or element, or with a different phase relative to the pilot channel, the MBMS service must be able to handle an additional pilot channel in the same cell. The additional pilot channel should have the same tilt that is used for the MBMS service. For the embodiment shown in FIG. 3, using two carriers, this is not a problem. Since there are already two carriers, each of these has an individual CPICH. For the embodiments of FIGS. 4 and 5 an additional pilot channel should be provided so that in the case with two different services with different tilts each service will have its own pilot channel. Each pilot channel should be transmitted with the same array of antenna elements and phase shifts as its corresponding service signal in order to get the same tilt.

1-14. (canceled)

15. An antenna system comprising:
an antenna array configured to transmit at least one signal on a corresponding carrier, the antenna array having at least two transmitting elements; and
a phase shift controller configured to control a phase shift of the antenna array to achieve an electrical tilt based on a type of service carried by the signal.

16. The antenna system of claim 15 wherein the at least two transmitting elements are active elements, and wherein the phase shift controller comprises:
a selector function to identify the type of service to be transmitted by the antenna array; and
an adjuster function to adjust the phase shift of the signals based on the type of service.

17. The antenna system of claim 15 further comprising a pilot function to provide a pilot channel for each signal, each pilot channel having a phase shift based on the phase shift of the signal.

18. The antenna system of claim 15 wherein the antenna array comprises a first antenna array and a second antenna array, each comprising passive antenna elements, and wherein the phase shift controller is further configured to introduce a first tilt to the signal transmitted to the first antenna array, and a second tilt, different from the first tilt, to the signal transmitted to the second antenna array.

19. The antenna system of claim 18 wherein the phase shift controller comprises:
a first knob to phase shift the signals to be transmitted on the first antenna array;
a second knob to electrically phase shift the signals to be transmitted on the second antenna array; and
a carrier selector to select one of the first and second antenna arrays to transmit an outgoing signal based on the type of service carried by the signal.

20. The antenna system of claim 18 wherein the phase shift controller comprises at least one electronic component configured to phase shift the signals.

21. The antenna system of claim 18 wherein the phase shift controller is configured to introduce a fixed phase shift to the signals.

22. A base station for use in a cellular telecommunications network, for controlling the transmission of signals through at least one antenna array, the base station comprising:
a control unit configured to control the transmission of a signal based on a type of service carried by the signal.

23. The base station of claim 22 wherein the control unit is configured to apply a phase shift to the signal based on the type of service carried by the signal to achieve a desired tilt.

24. The base station of claim 23 wherein the control unit is further configured to apply a phase shift to a pilot signal based on the phase shift applied to the signal.

25. The base station of claim 22 wherein the control unit is further configured to select one of at least two antenna arrays to transmit the signal based on the tilt applied to each antenna array, and on the type of service carried by the signal.

26. A computer readable medium for use in a base station operating in a communications network, the computer readable medium comprising computer readable code that, when executed by a control unit in the base station and responsive to the base station receiving a signal from the network that is to be transmitted to one or more mobile terminals, will cause the control unit to:
determine a type of service that is to be transmitted; and
control transmission of the signal such that the signal is transmitted with a desired tilt based on the type of service carried by the signal.

27. The computer readable medium of claim 26 wherein the computer readable code is further configured to control the transmission by applying an appropriate phase shift to achieve the desired tilt based on the service carried by the signal.

28. The computer readable medium of claim 26 wherein the computer readable code is further configured to control the transmission by selecting an antenna array to transmit the signal, the antenna array having the desired tilt based on the service carried by the signal.
